(19) United States
(12) Patent Application Publication
(10) Pub. No.: US 2020/0167864 A1
(43) Pub. Date: May 28, 2020

(54) INTEGRATED LENDING-AND-BROKERING ENVIRONMENT WITH ENTITY-RELATIONSHIP MANAGEMENT AND METHODS THEREOF

(71) Applicant: loanDepot.com, LLC, Foothill Ranch, CA (US)

(72) Inventors: Dominick Edilio Marchetti, Dove Canyon, CA (US); Tim Andrew Von Kaenel, Coto De Caza, CA (US)

(73) Assignee: loanDepot.com, LLC, Foothill Ranch, CA (US)

(21) Appl. No.: 16/697,008

(22) Filed: Nov. 26, 2019

Related U.S. Application Data
(60) Provisional application No. 62/771,500, filed on Nov. 26, 2018.

(51) Int. Cl. G06Q 40/02; G06Q 50/16; G06Q 20/08

(52) U.S. Cl. CPC G06Q 40/025; G06Q 20/0855; G06Q 50/165; G06Q 50/167

(57) ABSTRACT

Disclosed herein is an integrated lending-and-brokering environment including, in some embodiments, a lending platform, a brokering platform, third-party integration, and an entity-relationship management layer configured for information sharing among the lending platform, the brokering platform, and one or more third parties. The lending platform is configured to facilitate processing of lending-related information among lending personnel. The brokering platform is configured to facilitate processing of brokering-related information among brokering personnel. The third-party integration includes one or more interfaces with the lending-and-brokering environment, which allows the one or more third-parties to at least contribute additional information for the processing of the lending-and-brokering-related information. Information sharing among the lending platform, the brokering platform, and the one or more third parties facilitates selling one or more assets, buying one or more assets, or a combination thereof for a customer without a need for the customer to provide duplicative customer information.

### PRIORITY

This application claims the benefit of priority to U.S. Provisional Patent Application No. 62/771,500, filed Nov. 26, 2018, which is incorporated by reference in its entirety into this application.

### BACKGROUND

An important financial service provided by financial institutions is lending, which can include originating loans, servicing loans, or both originating and serving loans. There are many different types of loans available through such financial institutions. Broadly, the different types of loans are divided between secured loans and unsecured loans, wherein the secured loans are secured against borrowers' assets. Secured loans include, for example, mortgages, home equity loans, home equity lines of credit, or automotive loans. Unsecured loans include, for example, personal loans, personal lines of credit, student loans, or credit cards.

Lending, particularly originating loans such as mortgages, requires many fragmented, often manual processes of both borrowers and lenders. For a borrower, such processes include filling out a loan application and providing information in support of the loan application, the supporting information including, for example, employment, income, asset, and liability information. For a lender, such processes include processing the borrower's loan application and verifying the supporting information, underwriting a potential loan and performing a detailed risk assessment in view of the supporting information, and, ultimately, upon approval from underwriting, funding the loan. Moreover, such processes are highly specific to loan type. This obviates any financial benefit from economies of scale that could otherwise be passed onto borrowers and lenders alike if such processes were more tightly integrated, particularly with selling and buying real estate or other high-value assets. Accordingly, there is a need for a more highly automated, more tightly integrated lending platform that facilitates lending for at least secured loan types such as mortgages.

Disclosed herein is an integrated lending-and-brokering environment with entity-relationship management and methods thereof that address at least the foregoing need.

### SUMMARY

Disclosed herein is an integrated lending-and-brokering environment including, in some embodiments, a lending platform, a brokering platform, third-party integration, and an entity-relationship management layer configured for information sharing among the lending platform, the brokering platform, and one or more third parties. The lending platform is configured to facilitate processing of lending-related information among lending personnel. The brokering platform is configured to facilitate processing of brokering-related information among brokering personnel. The third-party integration includes one or more interfaces with the lending-and-brokering environment. The third-party integration allows the one or more third-parties to at least contribute additional information for the processing of the lending-related information, the brokering-related information, or both. By information sharing among the lending platform, the brokering platform, and the one or more third parties, the entity-relationship management layer facilitates selling one or more assets, buying one or more assets, or a combination thereof for a customer without a need for the customer to provide duplicative customer information to the lending personnel, the brokering personnel, or the one or more third parties.

In some embodiments, the lending platform includes a secured loan-lending system and an unsecured loan-lending system. The secured loan-lending system includes at least a mortgage-lending subsystem having a mortgage-originating subsystem and a mortgage-servicing subsystem. The unsecured loan-lending system includes at least a personal loan-lending subsystem having a personal loan-originating subsystem and a personal loan-servicing subsystem.

In some embodiments, the lending platform includes a lender-oriented application stack configured to run at least in part from a primary memory of at least one server host of the lending platform. The lender-oriented application stack includes one or more web servers, one or more application servers, and one or more database servers. The one or more application servers include at least a web application configured for the secured loan-lending system and at least a web application configured for the unsecured loan-lending system. The one or more database servers are configured to store the customer information in one or more databases for sharing among the lending personnel, the brokering personnel, or the one or more third parties.

In some embodiments, the brokering platform includes a real estate-brokering system and a home improvement-brokering system. The real estate-brokering system includes at least a home-buying subsystem, a home-selling subsystem, and a title-and-escrow-servicing subsystem. The home improvement-brokering system includes at least a purchasing subsystem and a servicing subsystem.

In some embodiments, the brokering platform includes a broker-oriented application stack configured to run at least in part from a primary memory of at least one server host of the brokering platform. The broker-oriented application stack includes one or more web servers, one or more application servers, and one or more database servers. The one or more application servers include at least a web application configured for the real estate-brokering system and at least a web application configured for the home improvement-brokering system. The one or more database servers are configured to store the customer information in one or more databases for sharing among the lending personnel, the brokering personnel, or the one or more third parties.

In some embodiments, the one or more interfaces with the lending-and-brokering environment include one or more application programming interfaces (“APIs”), one or more web applications, or at least one API and at least one web application.

In some embodiments, the integrated lending-and-brokering environment includes a customer-oriented web application of a customer-oriented application stack configured to run at least in part from a primary memory of at least one server host of the lending-and-brokering environment. The customer-oriented web application is configured to accept the customer information, inquiries regarding real estate, or a combination thereof. A web server of the customer-oriented application stack is configured to send the customer information or inquiries to the one or more third parties. The web application is further configured to display relevant information to the customer information or inquiries received from the one or more third parties, one or more options to proceed with a real estate transaction, or a combination thereof.

In some embodiments, a database server of the customer-oriented application stack is configured to store the customer information or inquiries sent to the one or more third parties, the relevant information to the customer information or inquiries received from the one or more third parties, or a combination thereof in one or more databases for the information sharing among the lending platform, the brokering platform, and the one or more third parties.

In some embodiments, the relevant information to the customer inquiries received from the one or more third parties is one or more customer-specific artificial intelligence-generated predictive insights into existing and upcoming real estate for sale.

In some embodiments, the customer information is at least details for real estate the customer would like to sell, the inquiries regarding real estate is at least details for real estate the customer would like to buy, and the one or more options to proceed with a real estate transaction is one or more financing options including at least a bridge loan based upon an instant appraisal for buying real estate corresponding to the details for real estate the customer would like to buy.

Also disclosed herein is non-transitory computer-readable media (“CRM”) including executable instructions that, when executed on one or more server hosts by at least an equal number of processors, cause the one or more server hosts to instantiate an integrated lending-and-brokering environment configured to perform a number of steps of a process of the integrated lending-and-brokering environment. The number of steps of the process of the lending-and-brokering environment include processing lending-related information for lending personnel with access to a lending platform of the lending-and-brokering environment configured to process the lending-related information; processing brokering-related information for brokering personnel with access to a brokering platform of the lending-and-brokering environment configured to process the brokering-related information; allowing one or more third-parties to at least contribute additional information for the processing of the lending-related information, the brokering-related information, or both by way of one or more interfaces for third-party integration with the lending-and-brokering environment; and; and sharing information among the lending platform, the brokering platform, and the one or more third parties by way of an entity-relationship management layer for information sharing. The number of steps of the process of the lending-and-brokering environment facilitate selling one or more assets, buying one or more assets, or a combination thereof for a customer without a need for the customer to provide duplicative customer information to the lending personnel, the brokering personnel, or the one or more third parties.

In some embodiments, the number of steps of the process of the lending-and-brokering environment further include instantiating a secured loan-lending system and an unsecured loan-lending system as part of the lending platform. The secured loan-lending system includes at least a mortgage-lending subsystem having a mortgage-originating subsystem and a mortgage-servicing subsystem. The unsecured loan-lending system includes at least a personal loan-lending subsystem having a personal loan-originating subsystem and a personal loan-servicing subsystem.

In some embodiments, the number of steps of the process of the lending-and-brokering environment further include operating a lender-oriented application stack of the lending platform at least in part from a primary memory of at least one server host of the lending platform. The lender-oriented application stack includes one or more web servers, one or more application servers, and one or more database servers. The one or more application servers include at least a web application configured for the secured loan-lending system and at least a web application configured for the unsecured loan-lending system. In addition, the number of steps of the process of the lending-and-brokering environment further include storing the customer information in one or more databases by one or more database servers of the lender-oriented application stack for sharing among the lending personnel, the brokering personnel, or the one or more third parties, as well as sharing among the lending personnel, the brokering personnel, or the one or more third parties the customer information in the one or more databases.

In some embodiments, the number of steps of the process of the lending-and-brokering environment include instantiating a real estate-brokering system and a home improvement-brokering system as part of the brokering platform. The real estate-brokering system includes at least a home-buying subsystem, a home-selling subsystem, and a title-and-escrow-servicing subsystem. The home improvement-brokering system includes at least a purchasing subsystem and a servicing subsystem.

In some embodiments, the number of steps of the process of the lending-and-brokering environment further include operating a broker-oriented application stack of the brokering platform at least in part from a primary memory of at least one server host of the brokering platform. The broker-oriented application stack includes one or more web servers, one or more application servers, and one or more database servers. The one or more application servers include at least a web application configured for the real estate-brokering system and at least a web application configured for the home improvement-brokering system. In addition, the number of steps of the process of the lending-and-brokering environment further include storing the customer information in one or more databases by one or more database servers of the broker-oriented application stack for sharing among the lending personnel, the brokering personnel, or the one or more third parties, as well as sharing among the lending personnel, the brokering personnel, or the one or more third parties the customer information in the one or more databases.

In some embodiments, the number of steps of the process of the lending-and-brokering environment further include providing one or more interfaces with the lending-and-brokering environment including one or more application programming interfaces (“APIs”), one or more web applications, or at least one API and at least one web application.

In some embodiments, the number of steps of the process of the lending-and-brokering environment further include instantiating a customer-oriented web application of a customer-oriented application stack configured to run at least in part from a primary memory of at least one server host of the lending-and-brokering environment; accepting by the customer-oriented web application the customer information, inquiries regarding real estate, or a combination thereof; sending by a web server of the customer-oriented application stack the customer information or inquiries to the one or more third parties; and displaying by the web application relevant information to the customer information or inquiries received from the one or more third parties, one or more options to proceed with a real estate transaction, or a combination thereof.

In some embodiments, the number of steps of the process of the lending-and-brokering environment further include storing the customer information or inquiries sent to the one or more third parties, the relevant information to the customer information or inquiries received from the one or more third parties, or a combination thereof as stored information in one or more databases by a database server of the customer-oriented application stack; and sharing the stored information among the lending platform, the brokering platform, and the one or more third parties.

In some embodiments, the relevant information to the customer inquiries received from the one or more third parties is one or more customer-specific artificial intelligence-generated predictive insights into existing and upcoming real estate for sale.

In some embodiments, the customer information is at least details for real estate the customer would like to sell, the inquiries regarding real estate is at least details for real estate the customer would like to buy, and the one or more options to proceed with a real estate transaction is one or more financing options including at least a bridge loan based upon an instant appraisal for buying real estate corresponding to the details for real estate the customer would like to buy.

These and other features of the concepts provided herein will become more apparent to those of skill in the art in view of the accompanying drawings and following description, which describe particular embodiments of such concepts in greater detail.

### DRAWINGS

FIG. 1 provides a schematic illustrating an integrated lending-and-brokering environment in accordance with some embodiments.

FIG. 2 provides a schematic illustrating a lending platform in accordance with some embodiments.

FIG. 3 provides a schematic illustrating brokering platform in accordance with some embodiments.

FIG. 4 provides a schematic illustrating the integrated lending-and-brokering environment supported by a number of server hosts networked with a number of client hosts in accordance with some embodiments.

FIG. 5 provides a schematic illustrating sharing of lending-related information for secured loans among at least lending personnel by way of the integrated lending-and-brokering environment networked in accordance with some embodiments.

FIG. 6 provides a schematic illustrating sharing of lending-related information for unsecured loans among at least lending personnel by way of the integrated lending-and-brokering environment networked in accordance with some embodiments.

FIG. 7 provides a schematic illustrating sharing of brokering-related information for buying and selling real estate among at least brokering personnel by way of the integrated lending-and-brokering environment networked in accordance with some embodiments.

FIG. 7 provides a schematic illustrating sharing of brokering-related information for home improvement among at least brokering personnel by way of the integrated lending-and-brokering environment networked in accordance with some embodiments.

FIG. 9 provides a schematic illustrating components of a network host in accordance with some embodiments.

### DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

Unless defined otherwise, all technical and scientific terms used herein have the same meaning as commonly understood by those of ordinary skill in the art.

As previously set forth, lending requires many fragmented, often manual processes of both borrowers and lenders. Moreover, such processes are highly specific to loan type. This obviates any financial benefit from economies of scale that could otherwise be passed onto borrowers and lenders alike if such processes were more tightly integrated and generalized across the loan types. Accordingly, there is a need for a more highly automated, more tightly integrated lending platform that dissolves lines between lending for secured and unsecured loan types.

Disclosed herein is an integrated lending-and-brokering environment with entity-relationship management and methods thereof that address at least the foregoing need.

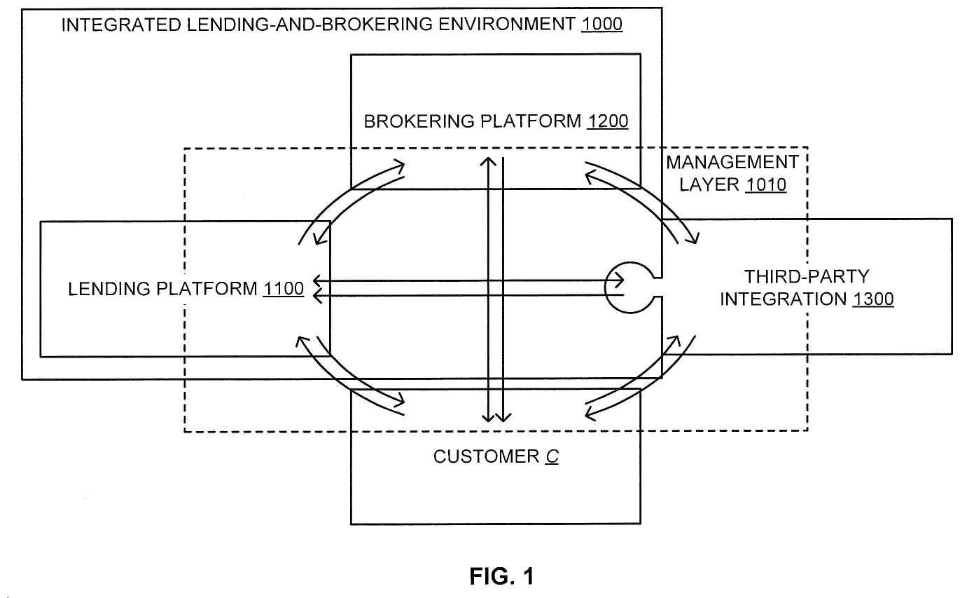

FIG. 1 provides a schematic illustrating an integrated lending-and-brokering environment 1000 in accordance with some embodiments.

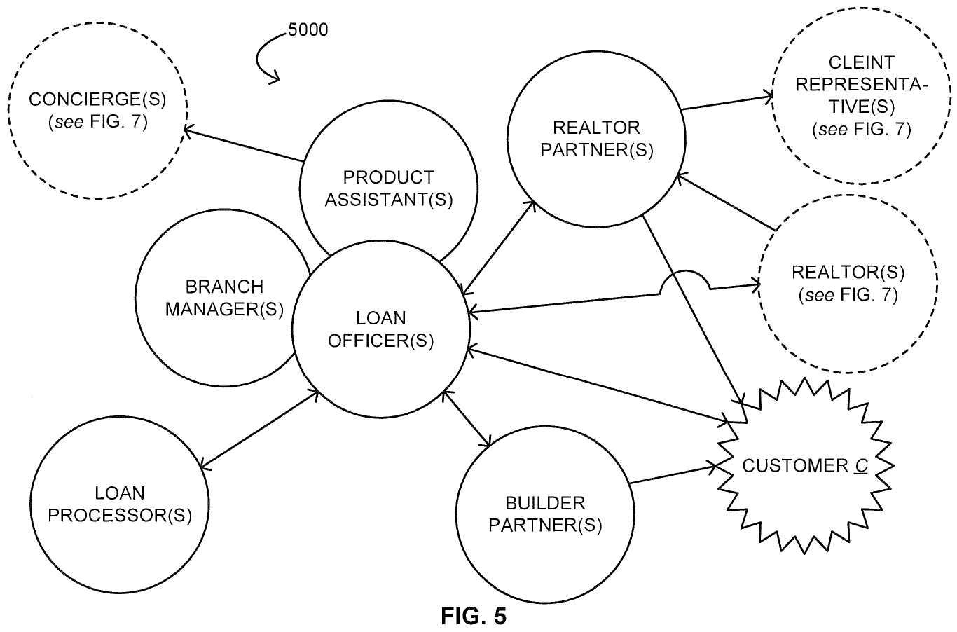

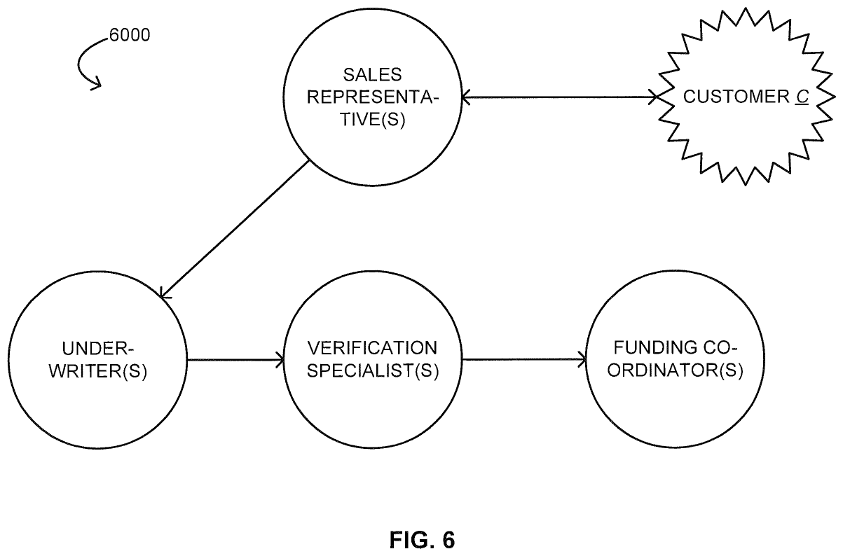

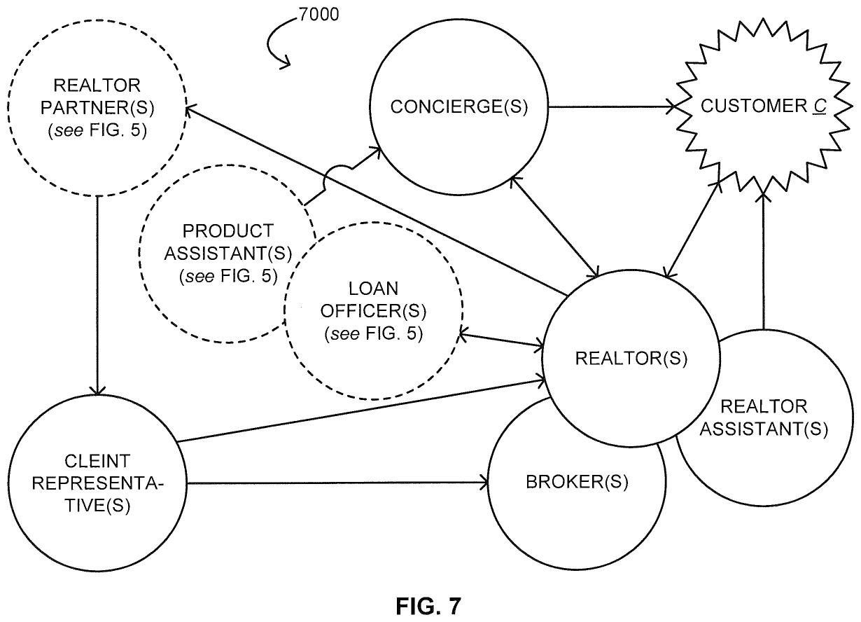

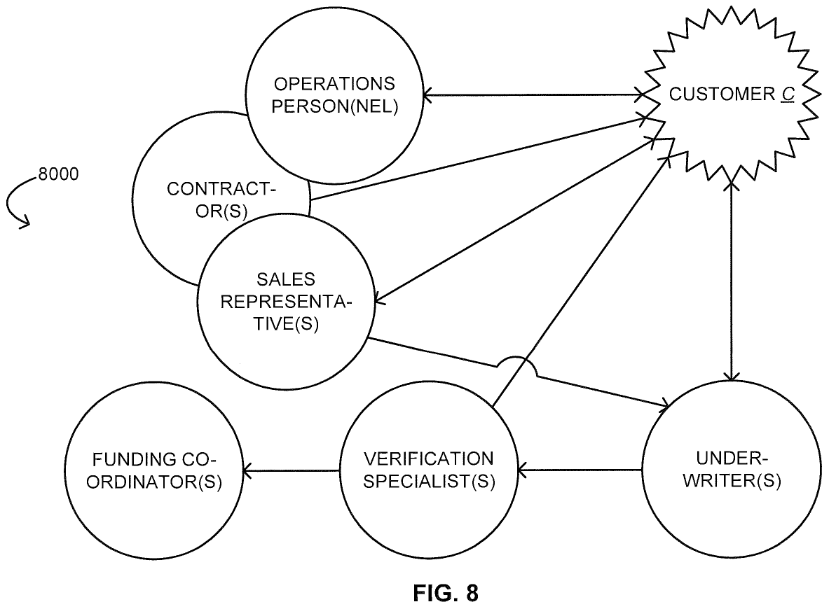

As shown in FIG. 1, the integrated lending-and-brokering environment 1000 includes, in some embodiments, a lending platform 1100, a brokering platform 1200, third-party integration 1300, and an entity-relationship management layer 1010 configured for information sharing among the lending platform 1100, the brokering platform 1200, and one or more third parties through the third-party integration 1300. The lending platform 1100 is configured to facilitate processing of lending-related information among lending personnel. (See FIGS. 5 and 6.) The brokering platform 1200 is configured to facilitate processing of brokering-related information among brokering personnel. (See FIGS. 7 and 8.) The third-party integration 1300 includes one or more interfaces with the integrated lending-and-brokering environment 1000 such as one or more application programming interfaces (“APIs”), one or more web applications, or at least one API and at least one web application. The third-party integration 1300 allows the one or more third-parties to at least contribute additional information for the processing of the lending-related information, the brokering-related information, or both. By information sharing among the lending platform 1100, the brokering platform 1200, and the one or more third parties through the third-party integration 1300, the entity-relationship management layer 1010 facilitates selling one or more assets such as real estate, buying one or more assets such as real estate, or a combination thereof for a customer without a need for the customer to provide duplicative customer information to the lending personnel, the brokering personnel, or the one or more third parties. For example, the integrated lending-and-brokering environment 1000 allows a customer to improve existing real estate through the brokering platform 1200 (see FIG. 8), sell the existing real estate through the brokering platform 1200 (see FIG. 7), buy new real estate through the brokering platform 1200 (see FIG. 7), and fund the purchase of the new real estate with a bridge loan through the lending platform 1100 (see FIG. 5).

In addition to saving time for the foregoing customer and lending or brokering personnel, obviating the need for customers to provide duplicative customer information to the lending and brokering personnel also reduces demands on server hosts (e.g., the server hosts 4010, 4020, 4030, and 4040 set forth below) in support of the integrated lending-and-brokering environment 1000. Reducing demand on the server hosts with respect to, for example, fetching customer information from two or more server locations or even resolving slight inconsistencies in the customer information in the two or more server locations provides an improvement of the integrated lending-and-brokering environment 1000 over existing systems, platforms, or the like for lending or brokering that are not as tightly integrated. The improvement is realized with respect to lowered capital costs such as through purchase of fewer storage devices, as well as lowered operating costs such as through purchase of less power on an ongoing basis to run the integrated lending-and-brokering environment 1000.

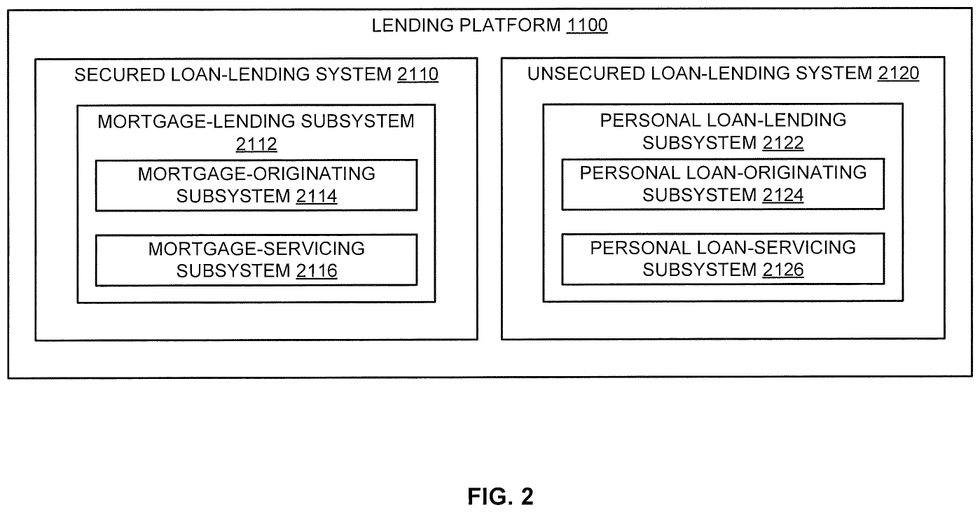

FIG. 2 provides a schematic illustrating the lending platform 1100 in accordance with some embodiments.

As shown in FIG. 2, the lending platform 1100 includes a secured loan-lending system 2110 and an unsecured loan-lending system 2120. The secured loan-lending system 2110 includes at least a mortgage-lending subsystem 2112 having a mortgage-originating subsystem 2114 and a mortgage-servicing subsystem 2116. The unsecured loan-lending system 2120 includes at least a personal loan-lending subsystem 2122 having a personal loan-originating subsystem 2124 and a personal loan-servicing subsystem 2126.

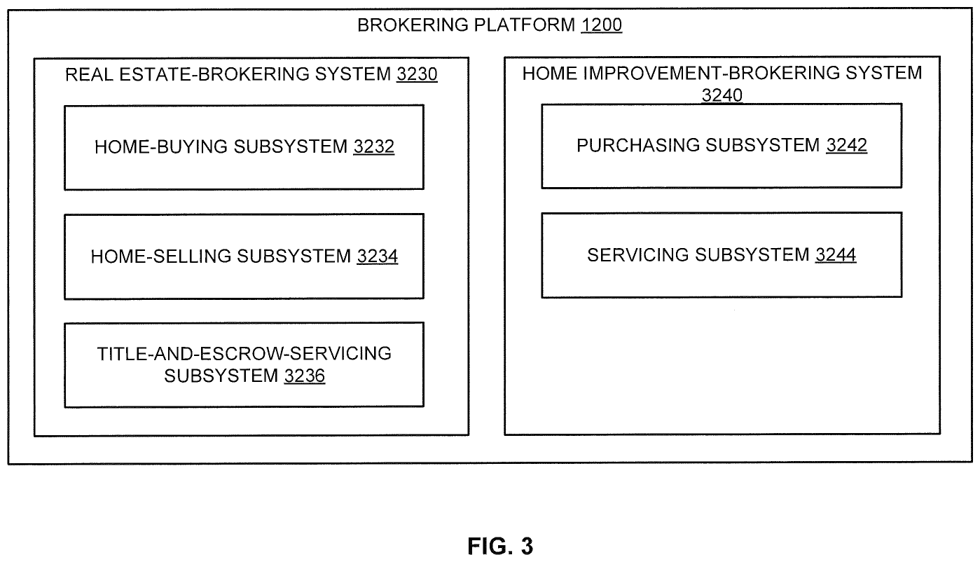

FIG. 3 provides a schematic illustrating brokering platform 1200 in accordance with some embodiments.

As shown in FIG. 3, the brokering platform 1200 includes a real estate-brokering system 3230 and a home improvement-brokering system 3240. The real estate-brokering system 3230 includes at least a home-buying subsystem 3232, a home-selling subsystem 3234, and a title-and-escrow-servicing subsystem 3236. The home improvement-brokering system 3240 includes at least a purchasing subsystem 3242 and a servicing subsystem 3244.

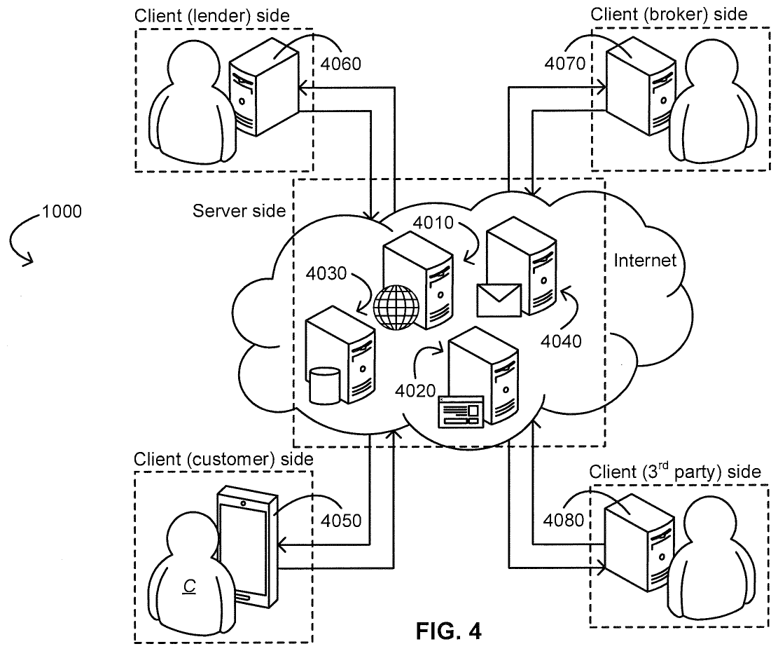

FIG. 4 provides a schematic illustrating the integrated lending-and-brokering environment 1000 supported by a number of server hosts 4010, 4020, 4030, and 4040 networked with a number of client hosts 4050, 4060, 4070, and 4080 in accordance with some embodiments.

The integrated lending-and-brokering environment 1000 includes one or more application stacks, each application stack of which is independently configured to run at least in part from a primary memory of at least one server host of the server hosts 4010, 4020, 4030, and 4040 of the integrated lending-and-brokering environment 1000. The one or more application stacks include, but are not limited to, a customer-oriented application stack, a lender-oriented application stack, a broker-oriented application stack, a third party-oriented application stack, or a combination thereof.

As shown in FIG. 4, the server hosts 4010, 4020, 4030, and 4040 supporting the integrated lending-and-brokering environment 1000 and the one or more application stacks thereof can include a web server, an application server, a database server with an associated database, an e-mail server configured to send and receive secured e-mail messages, or a combination thereof. For expository convenience, the server host 4010 is shown to support the web server, the server host 4020 is shown to support the application server, the server host 4030 is shown to support the database server, and the server host 4040 is shown to support the e-mail server; however, the web server, the application server, the database server, and the e-mail server can be supported by any one or more of the server hosts 4010, 4020, 4030, and 4040 in any of a number of ways. Optionally, the server hosts 4010, 4020, 4030, and 4040 further support mobile device-oriented server counterparts such as a mobile web server or a mobile application server if such mobile device-oriented server counterparts are not already integrated with their counterpart servers.

With respect to the customer-oriented application stack, an application server of the customer-oriented application stack supported by, for example, the server host 4020 can include a customer-oriented web application server module (not shown) configured to service requests from one of more client hosts such as a customer's client host 4050 for a customer-oriented web application. The customer-oriented web application server module can be a mobile web application server module configured to service requests from one of more mobile devices (e.g., smart phones, tablet computers, etc.) for a mobile web application version of the customer-oriented web application.

With respect to the lender-oriented application stack, the lender-oriented application stack is configured to run at least in part from a primary memory of at least one server host of the lending platform 1100. The lender-oriented application stack includes one or more web servers, one or more application servers, and one or more database servers. The one or more application servers supported by, for example, the server host 4020, can include a lender-oriented web application server module (not shown) configured to service requests from one of more client hosts such as a lender's client host 4060 for a lender-oriented web application. The lender-oriented web application server module can be a mobile web application server module configured to service requests from one of more mobile devices (e.g., smart phones, tablet computers, etc.) for a mobile web application version of the lender-oriented web application. The web application can be configured for the secured loan-lending system 2110, the unsecured loan-lending system 2120, or both. The one or more database servers supported by, for example, the server host 4030 can be configured to store the customer information in one or more databases for sharing among the lending personnel, the brokering personnel, or the one or more third parties.

With respect to the broker-oriented application stack, the broker-oriented application stack is configured to run at least in part from a primary memory of at least one server host of the brokering platform 1200. The broker-oriented application stack includes one or more web servers, one or more application servers, and one or more database servers. The one or more application servers supported by, for example, the server host 4020, can include a broker-oriented web application server module (not shown) configured to service requests from one of more client hosts such as a broker's client host 4070 for a broker-oriented web application. The broker-oriented web application server module can be a mobile web application server module configured to service requests from one of more mobile devices (e.g., smart phones, tablet computers, etc.) for a mobile web application version of the broker-oriented web application. The web application can be configured for the real estate-brokering system 3230, the home improvement-brokering system 3240, or both. The one or more database servers supported by, for example, the server host 4030 can be configured to store the customer information in one or more databases for sharing among the lending personnel, the brokering personnel, or the one or more third parties.

With respect to the third party-oriented application stack, an application server of the third party-oriented application stack supported by, for example, the server host 4020 can include a third party-oriented web application server module (not shown) configured to service requests from one of more client hosts such as a third party's client host 4080 for a third party-oriented web application. The third party-oriented web application server module can be a mobile web application server module configured to service requests from one of more mobile devices (e.g., smart phones, tablet computers, etc.) for a mobile web application version of the third party-oriented web application.

Thus, the integrated lending-and-brokering environment 1000 further includes the customer-oriented web application, the lender-oriented web application, the broker-related web application, and, optionally, the third party-oriented web application in addition to the one or more application stacks thereof. The customer-oriented web application is configured to run at least in part from a primary memory of a first client host such as the customer's client host 4050 (e.g., mobile device, personal computer, etc.). The lender-oriented web application is configured to run at least in part from a primary memory of a second client host such as the lender's client host 4060 (e.g., personal computer, mobile device, etc.). The broker-oriented web application is configured to run at least in part from a primary memory of a third client host such as the broker's client host 4070 (e.g., personal computer, mobile device, etc.). Optionally, the third party-oriented web application is configured to run at least in part from a primary memory of a fourth client host such as the third party's client host 4080 (e.g., personal computer, mobile device, etc.). The customer-oriented web application, the lender-oriented web application, the broker-related web application, and the third party-oriented web application are configured for information sharing by way of the entity-relationship management layer 1010.

While the foregoing sets forth a number of web applications for client hosts, it should be understood that such client hosts can alternatively run local applications native to the operating systems of the client hosts.

The customer-oriented web application is configured to accept customer information, inquiries regarding real estate, or a combination thereof by way of a web server of the customer-oriented application stack supported by, for example, the server host 4010. The customer information can include, but is not limited to, details for real estate the customer would like to sell. The inquiries can include, but are not limited to, inquiries for details regarding real estate the customer would like to buy. A database server of the customer-oriented application stack supported by, for example, the server host 4030 is configured to store the customer information or inquiries in one or more databases for sharing among the lending personnel, the brokering personnel, or the one or more third parties. A same or different web server than that of the server host 4010 or an API can be configured to send the customer information or inquiries to the lending personnel, the brokering personnel, or the one or more third parties. Any information relevant to the customer information or inquiries received from the lending personnel, the brokering personnel, or the one or more third parties can be stored in the one or more databases for further sharing among the lending personnel, the brokering personnel, or the one or more third parties. The information relevant to the customer inquiries received from the one or more third parties can include, but is not limited to, an instant appraisal or one or more customer-specific artificial intelligence-generated predictive insights into existing and upcoming real estate for sale. The customer-oriented web application is further configured to display the information relevant to the customer information or inquiries received from the lending personnel, the brokering personnel, or the one or more third parties, as well as one or more options to proceed with a real estate transaction. The one or more options to proceed with a real estate transaction can be one or more financing options including at least a bridge loan based upon an instant appraisal for buying real estate corresponding to the details for real estate the customer would like to buy. From the perspective of the customer, the display of the information relevant to the customer information or inquiries occurs in real-time.

FIG. 5 provides a schematic illustrating sharing of lending-related information for secured loans among at least lending personnel 5000 by way of the integrated lending-and-brokering environment networked in accordance with some embodiments.

As shown in FIG. 5, the lending personnel 5000 include at least loan officers, loan product assistants, loan processors, and branch managers for originating secured loans such as mortgages. Such lending personnel can share lending-related information on the lending platform 1100, as well as outside the lending platform 1100 by way of the entity-relationship management layer 1010 of the integrated lending-and-brokering environment 1000. For example, the lending personnel 5000 can share lending-related information with brokering personnel on the brokering platform 1200. This allows loan officers to share customer information with realtors to facilitate customer purchases of real estate.

FIG. 6 provides a schematic illustrating sharing of lending-related information for unsecured loans among at least lending personnel by way of the integrated lending-and-brokering environment networked in accordance with some embodiments.

As shown in FIG. 6, the lending personnel 6000 include at least sales representatives, underwriters, verification specialists, and funding coordinators for originating unsecured loans such as personal loans. Such lending personnel can share lending-related information on the lending platform 1100, as well as outside the lending platform 1100 by way of the entity-relationship management layer 1010 of the integrated lending-and-brokering environment 1000.

FIG. 7 provides a schematic illustrating sharing of brokering-related information for buying and selling real estate among at least brokering personnel by way of the integrated lending-and-brokering environment networked in accordance with some embodiments.

As shown in FIG. 7, the brokering personnel 7000 include at least concierges, realtors, realtor assistants, and brokers for buying and selling real estate such as homes. Such brokering personnel can share brokering-related information on the brokering platform 1200, as well as outside the brokering platform 1200 by way of the entity-relationship management layer 1010 of the integrated lending-and-brokering environment 1000. For example, the brokering personnel 7000 can share brokering-related information with lending personnel on the lending platform 1100. This allows realtors to share customer information with loan officers to facilitate customer purchases of real estate.

FIG. 8 provides a schematic illustrating sharing of brokering-related information for home improvement among at least brokering personnel by way of the integrated lending-and-brokering environment networked in accordance with some embodiments.

As shown in FIG. 8, the brokering personnel 8000 include at least sales representatives, contractors, and operations personnel for buying services and materials for home improvement. Such brokering personnel can share brokering-related information on the brokering platform 1200, as well as outside the brokering platform 1200 by way of the entity-relationship management layer 1010 of the integrated lending-and-brokering environment 1000. For example, the brokering personnel 8000 can share brokering-related information with lending personnel on the lending platform 1100. This allows contractors or builders to share customer information with loan officers to facilitate customer purchases of home improvements or real estate.

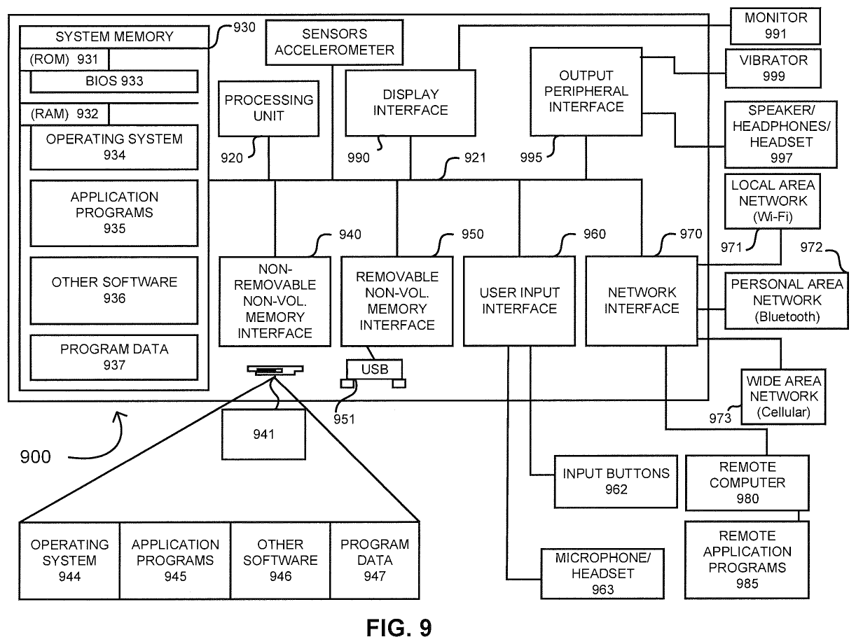

FIG. 9 provides a schematic illustrating components of a network host 900 such as any one or more server hosts of the integrated lending-and-brokering environment 1000 in accordance with some embodiments. Components of the network host 900 vary in accordance with host type. As such, each and every component shown and described in reference to FIG. 9 need not be included in each host type. Furthermore, each host type can further include components not shown or described in reference to FIG. 9 but otherwise described herein.

As shown, components of the network host 900 can include, but are not limited to, a processing unit 920 having one or more processing cores, a primary or system memory 930, and a system bus 921 that couples various system components including the system memory 930 to the processing unit 920. The system bus 921 can be any of several types of bus structures selected from a memory bus or memory controller, a peripheral bus, and a local bus using any of a variety of bus architectures.

The network host 900 can include a variety of computer-readable media. Computer-readable media can be any media that can be accessed by the network host 900 and includes both volatile and nonvolatile media, as well as removable and non-removable media. By way of example, and not limitation, use of computer-readable media includes storage of information, such as computer-readable instructions, data structures, other executable software, or other data. Computer-readable media includes, but is not limited to, RAM, ROM, EEPROM, flash memory or other memory technology, CD-ROM, digital versatile disks (“DVD”) or other optical disk storage, magnetic cassettes, magnetic tape, magnetic disk storage or other magnetic storage devices, or any other tangible medium that can be used to store the desired information for access by the network host 900. Transitory media such as wireless channels are not included in the computer-readable media. Communication media typically embody computer-readable instructions, data structures, other executable software, or other transport mechanisms and includes any information delivery media. As an example, some client hosts on a network might not have optical or magnetic storage.

The system memory 930 includes computer-readable media in the form of volatile or nonvolatile memory such as read only memory (“ROM”) 931 and random-access memory (“RAM”) 932. A basic input-output system 933 (“BIOS”) containing the basic routines that help to transfer information between elements within the network host 900, such as during start-up, is typically stored in the ROM 931. The RANI 932 typically contains software or data that are immediately accessible for operations by the processing unit 920. By way of example, and not limitation, FIG. 9 illustrates that the RAM 932 can include a portion of the operating system 934, application programs 935, other executable software 936, and program data 937.

The network host 900 can also include other computer-readable media. By way of example only, FIG. 9 illustrates a solid-state memory 941. Other computer-readable media that can be used in the example operating environment include, but are not limited to, universal serial bus (“USB”) drives and devices, flash memory cards, solid state RAM, solid state ROM, or the like. The solid-state memory 941 is typically connected to the system bus 921 through a non-removable memory interface such as interface 940, and USB drive 951 is typically connected to the system bus 921 by a removable memory interface such as interface 950.

The drives and their associated computer-readable media provide storage of computer-readable instructions, data structures, other executable software, or other data for the network host 900. In FIG. 9, for example, the solid-state memory 941 is illustrated for storing operating system 944, application programs 945, other executable software 946, or program data 947. Note that these components can either be the same as or different from the operating system 934, the application programs 935, the other executable software 936, and the program data 937. The operating system 944, the application programs 945, the other executable software 946, and the program data 947 are given different numbers here to illustrate that, at a minimum, they are different copies.

A user can enter commands and information into the network host 900 through input devices such as a keyboard, touchscreen, or software or hardware input buttons 962, a microphone 963, a pointing device such as a mouse, or scrolling input component such as a trackball or touch pad. The microphone 963 can cooperate with speech recognition software. These and other input devices are often connected to the processing unit 920 through a user input interface 960 that is coupled to the system bus 921 but can be connected by other interface and bus structures, such as a parallel port, game port, or USB. A display monitor 991 or other type of display screen device is also connected to the system bus 921 via an interface such as a display interface 990. In addition to the monitor 991, the network host 900 can also include other peripheral output devices such as speakers 997, a vibrator 999, and other output devices, which can be connected through an output peripheral interface 995.

The network host 900 can operate in a networked environment using logical connections to one or more other network hosts such as network host 980. Like the network host 900, the network host 980 can be a personal computer, a server, a router, a network PC, a peer device, or another network node. The logical connections depicted in FIG. 9 can include a personal area network (“PAN”) 972 (e.g., Bluetooth®), a local area network (“LAN”) 971 (e.g., Wi-Fi), and a wide area network (“WAN”) 973 (e.g., cellular network), but can also include other networks such as a personal area network (e.g., Bluetooth®). Such networking environments are commonplace in offices, enterprise-wide computer networks, intranets and the Internet. A browser application can be resident on the network host 900 and stored in the memory.

When used in a LAN networking environment, the network host 900 is connected to the LAN 971 through a network interface or adapter 970, which can be, for example, a Bluetooth® or Wi-Fi adapter. When used in a WAN networking environment (e.g., Internet), the network host 900 can include some means for establishing communications over the WAN 973. With respect to telecommunication technologies, for example, a radio interface, which can be internal or external, can be connected to the system bus 921 via the network interface or adapter 970, or another appropriate mechanism. In a networked environment, other software depicted relative to the network host 900, or portions thereof, can be stored in the remote memory storage device. By way of example, and not limitation, FIG. 9 illustrates remote application programs 985 as residing on the network host 980. It will be appreciated that the network connections shown are examples and other means of establishing a communications link between the network hosts can be used.

As discussed, the network host 900 can include the processor 920, memory (e.g., ROM 931, RAM 932, etc.), an AC power input, a display screen, and built-in Wi-Fi circuitry to wirelessly communicate with other network hosts connected to the network.

Another device that can be coupled to the system bus 921 is a power supply such as a DC power supply (e.g., battery) or an AC adapter circuit. As discussed above, the DC power supply can be a battery, a fuel cell, or similar DC power source that needs to be recharged on a periodic basis. A wireless communication module can employ a Wireless Application Protocol to establish a wireless communication channel. The wireless communication module can implement a wireless networking standard.

In some embodiments, software used to facilitate algorithms discussed herein can be embodied into a non-transitory computer-readable medium. A computer-readable medium includes any mechanism that stores information in a form readable by a computer. For example, a non-transitory machine-readable medium can include ROM; RAM; magnetic disk storage media; optical storage media; flash memory devices; DVDs, EPROMs, EEPROMs, FLASH memory, magnetic or optical cards, or any type of media suitable for storing electronic instructions.

An application described herein includes, but is not limited to, software applications and programs that are part of an operating system or integrated with or on an application layer thereof. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C+, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a network host, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry.

### Methods

A non-transitory CRM can include executable instructions that, when executed on one or more server hosts such as the server hosts 4010, 4020, 4030, and 4040 of FIG. 4 by at least an equal number of processors, cause the one or more server hosts to instantiate the integrated lending-and-brokering environment 1000 configured to perform a number of operations of the integrated lending-and-brokering environment 1000. The number of steps of the process of the integrated lending-and-brokering environment 1000 include processing lending-related information for the lending personnel 5000 or 6000 with access to the lending platform 1100 of the integrated lending-and-brokering environment 1000 configured to process the lending-related information; processing brokering-related information for the brokering personnel 7000 or 8000 with access to the brokering platform 1200 of the integrated lending-and-brokering environment 1000 configured to process the brokering-related information; allowing one or more third-parties to at least contribute additional information for the processing of the lending-related information, the brokering-related information, or both by way of one or more interfaces for third-party integration with the integrated lending-and-brokering environment 1000; and sharing information among the lending platform 1100, the brokering platform 1200, and the one or more third parties by way of the entity-relationship management layer 1010 for information sharing. The number of steps of the process of the integrated lending-and-brokering environment 1000 facilitate selling one or more assets, buying one or more assets, or a combination thereof for a customer without a need for the customer to provide duplicative customer information to the lending personnel, the brokering personnel, or the one or more third parties. In effect, the integrated lending-and-brokering environment 1000 is a one-stop shop for customers.

Operations of the integrated lending-and-brokering environment 1000 further include instantiating the secured loan-lending system 2110 and the unsecured loan-lending system 2120 as part of the lending platform 1100. The secured loan-lending system 2110 includes at least the mortgage-lending subsystem 2112 having the mortgage-originating subsystem 2114 and the mortgage-servicing subsystem 2116. The unsecured loan-lending system 2120 includes at least the personal loan-lending subsystem 2122 having the personal loan-originating subsystem 2124 and the personal loan-servicing subsystem 2126.

Operations of the integrated lending-and-brokering environment 1000 further include operating the lender-oriented application stack of the lending platform 1100 at least in part from a primary memory of at least one server host of the lending platform 1100. The lender-oriented application stack includes one or more web servers, one or more application servers, and one or more database servers. The one or more application servers include at least a web application configured for the secured loan-lending system 2110 and at least a web application configured for the unsecured loan-lending system 2120. In addition, operations of the lending-and-brokering environment 1000 further include storing the customer information in one or more databases by one or more database servers of the lender-oriented application stack for sharing among the lending personnel 5000 or 6000, the brokering personnel 7000 or 8000, or the one or more third parties, as well as sharing among the lending personnel 5000 or 6000, the brokering personnel 7000 or 8000, or the one or more third parties the customer information in the one or more databases.

Operations of the lending-and-brokering environment include instantiating the real estate-brokering system 3230 and the home improvement-brokering system 3240 as part of the brokering platform 1200. The real estate-brokering system 3230 includes at least the home-buying subsystem 3232, the home-selling subsystem 3234, and the title-and-escrow-servicing subsystem 3236. The home improvement-brokering system 3240 includes at least the purchasing subsystem 3242 for purchasing materials and services for home improvement and a servicing subsystem for tracking particular service jobs.

Operations of the integrated lending-and-brokering environment 1000 further include operating a broker-oriented application stack of the brokering platform 1200 at least in part from a primary memory of at least one server host of the brokering platform 1200. The broker-oriented application stack includes one or more web servers, one or more application servers, and one or more database servers. The one or more application servers include at least a web application configured for the brokering platform 1200 and at least a web application configured for the home improvement-brokering system 3240. In addition, operations of the integrated lending-and-brokering environment 1000 further include storing the customer information in one or more databases by one or more database servers of the broker-oriented application stack for sharing among the lending personnel 5000 or 6000, the brokering personnel 7000 or 8000, or the one or more third parties, as well as sharing among the lending personnel 5000 or 6000, the brokering personnel 7000 or 8000, or the one or more third parties the customer information in the one or more databases.

Operations of the integrated lending-and-brokering environment 1000 further include providing one or more interfaces with the integrated lending-and-brokering environment 1000 including one or more application programming interfaces (“APIs”), one or more web applications, or at least one API and at least one web application.

Operations of the integrated lending-and-brokering environment 1000 further include instantiating a customer-oriented web application of a customer-oriented application stack configured to run at least in part from a primary memory of at least one server host of the integrated lending-and-brokering environment 1000; accepting by the customer-oriented web application the customer information, inquiries regarding real estate, or a combination thereof; sending by a web server of the customer-oriented application stack the customer information or inquiries to the one or more third parties; and displaying by the web application relevant information to the customer information or inquiries received from the one or more third parties, one or more options to proceed with a real estate transaction, or a combination thereof.

Operations of the integrated lending-and-brokering environment 1000 further include storing the customer information or inquiries sent to the one or more third parties, the relevant information to the customer information or inquiries received from the one or more third parties, or a combination thereof as stored information in one or more databases by a database server of the customer-oriented application stack; and sharing the stored information among the lending platform 1100, the brokering platform 1200, and the one or more third parties.

The information relevant to the customer inquiries received from the one or more third parties is one or more customer-specific artificial intelligence-generated predictive insights into existing and upcoming real estate for sale.

The customer information is at least details for real estate the customer would like to sell, the inquiries regarding real estate is at least details for real estate the customer would like to buy, and the one or more options to proceed with a real estate transaction is one or more financing options including at least a bridge loan based upon an instant appraisal for buying real estate corresponding to the details for real estate the customer would like to buy.

The concepts provided herein including the particular embodiments thereof represent a technological advancement in lending and brokering, particularly lending with respect to mortgages and brokering with respect to selling and buying real estate or other high-value assets, which are generally highly fragmented among many entities involved in the lending and brokering. The integrated lending-and-brokering environment incorporates computer-related technology in order to provide tight integration including sharing among lending and brokering platforms as well as third parties to provide such a technological advancement. At least one example is providing one or more financing options including a bridge loan based upon a third-party instant appraisal for buying real estate in consideration of selling other real estate.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. An integrated lending-and-brokering environment, comprising:
a lending platform configured to facilitate processing of lending-related information among lending personnel;
a brokering platform configured to facilitate processing of brokering-related information among brokering personnel;
third-party integration by way of one or more interfaces with the lending-and-brokering environment, the third-party integration allowing one or more third-parties to at least contribute additional information for the processing of the lending-related information, the brokering-related information, or both; and
an entity-relationship management layer configured to facilitate information sharing among the lending platform, the brokering platform, and the one or more third parties, thereby facilitating selling one or more assets, buying one or more assets, or a combination thereof for a customer without a need for the customer to provide duplicative customer information to the lending personnel, the brokering personnel, or the one or more third parties.

2. The integrated lending-and-brokering environment of claim 1,
wherein the lending platform includes a secured loan-lending system and an unsecured loan-lending system,
wherein the secured loan-lending system includes at least a mortgage-lending subsystem having a mortgage-originating subsystem and a mortgage-servicing subsystem, and
wherein the unsecured loan-lending system includes at least a personal loan-lending subsystem having a personal loan-originating subsystem and a personal loan-servicing subsystem.

3. The integrated lending-and-brokering environment of claim 2,
wherein the lending platform includes a lender-oriented application stack configured to run at least in part from a primary memory of at least one server host of the lending platform, the lender-oriented application stack including one or more web servers, one or more application servers, and one or more database servers,
wherein the one or more application servers include at least a web application configured for the secured loan-lending system and at least a web application configured for the unsecured loan-lending system, and
wherein the one or more database servers are configured to store the customer information in one or more databases for sharing among the lending personnel, the brokering personnel, or the one or more third parties.

4. The integrated lending-and-brokering environment of claim 1,
wherein the brokering platform includes a real estate-brokering system and a home improvement-brokering system,
wherein the real estate-brokering system includes at least a home-buying subsystem, a home-selling subsystem, and a title-and-escrow-servicing subsystem, and
wherein the home improvement-brokering system includes at least a purchasing subsystem and a servicing subsystem.

5. The integrated lending-and-brokering environment of claim 4,
wherein the brokering platform includes a broker-oriented application stack configured to run at least in part from a primary memory of at least one server host of the brokering platform, the broker-oriented application stack including one or more web servers, one or more application servers, and one or more database servers,
wherein the one or more application servers include at least a web application configured for the real estate-brokering system and at least a web application configured for the home improvement-brokering system, and
wherein the one or more database servers are configured to store the customer information in one or more databases for sharing among the lending personnel, the brokering personnel, or the one or more third parties.

6. The integrated lending-and-brokering environment of claim 1,
wherein the one or more interfaces with the lending-and-brokering environment include one or more application programming interfaces (“APIs”), one or more web applications, or at least one API and at least one web application.

7. The integrated lending-and-brokering environment of claim 6,
wherein the integrated lending-and-brokering environment includes a customer-oriented web application of a customer-oriented application stack configured to run at least in part from a primary memory of at least one server host of the lending-and-brokering environment,
wherein the customer-oriented web application is configured to i) accept the customer information, inquiries regarding real estate, or a combination thereof, ii) a web server of the customer-oriented application stack is configured to send the customer information or inquiries to the one or more third parties, and iii) the web application is further configured to display relevant information to the customer information or inquiries received from the one or more third parties, one or more options to proceed with a real estate transaction, or a combination thereof.

8. The integrated lending-and-brokering environment of claim 7,
wherein a database server of the customer-oriented application stack is configured to store the customer information or inquiries sent to the one or more third parties, the relevant information to the customer information or inquiries received from the one or more third parties, or a combination thereof in one or more databases for the information sharing among the lending platform, the brokering platform, and the one or more third parties.

9. The integrated lending-and-brokering environment of claim 7,
wherein the relevant information to the customer inquiries received from the one or more third parties is one or more customer-specific artificial intelligence-generated predictive insights into existing and upcoming real estate for sale.

10. The integrated lending-and-brokering environment of claim 7,
wherein the customer information is at least details for real estate the customer would like to sell, the inquiries regarding real estate is at least details for real estate the customer would like to buy, and the one or more options to proceed with a real estate transaction is one or more financing options including at least a bridge loan based upon an instant appraisal for buying real estate corresponding to the details for real estate the customer would like to buy.

11. Non-transitory computer-readable media (“CRM”) including executable instructions that, when executed on one or more server hosts by at least an equal number of processors, cause the one or more server hosts to instantiate an integrated lending-and-brokering environment configured to perform a plurality of steps, comprising:
processing lending-related information for lending personnel with access to a lending platform of the lending-and-brokering environment configured to process the lending-related information;
processing brokering-related information for brokering personnel with access to a brokering platform of the lending-and-brokering environment configured to process the brokering-related information;
allowing one or more third-parties to at least contribute additional information for the processing of the lending-related information, the brokering-related information, or both by way of one or more interfaces for third-party integration with the lending-and-brokering environment; and
sharing information among the lending platform, the brokering platform, and the one or more third parties by way of an entity-relationship management layer for information sharing, thereby facilitating selling one or more assets, buying one or more assets, or a combination thereof for a customer without a need for the customer to provide duplicative customer information to the lending personnel, the brokering personnel, or the one or more third parties.

12. The CRM of claim 11, further comprising:
instantiating a secured loan-lending system and an unsecured loan-lending system as part of the lending platform,
wherein the secured loan-lending system includes at least a mortgage-lending subsystem having a mortgage-originating subsystem and a mortgage-servicing subsystem, and
wherein the unsecured loan-lending system includes at least a personal loan-lending subsystem having a personal loan-originating subsystem and a personal loan-servicing subsystem.

13. The CRM of claim 12, further comprising:
operating a lender-oriented application stack of the lending platform at least in part from a primary memory of at least one server host of the lending platform, the lender-oriented application stack including one or more web servers, one or more application servers, and one or more database servers,
wherein the one or more application servers include at least a web application configured for the secured loan-lending system and at least a web application configured for the unsecured loan-lending system;
storing the customer information in one or more databases by one or more database servers of the lender-oriented application stack for sharing among the lending personnel, the brokering personnel, or the one or more third parties; and
sharing among the lending personnel, the brokering personnel, or the one or more third parties the customer information in the one or more databases.

14. The CRM of claim 11, further comprising:
instantiating a real estate-brokering system and a home improvement-brokering system as part of the brokering platform,
wherein the real estate-brokering system includes at least a home-buying subsystem, a home-selling subsystem, and a title-and-escrow-servicing subsystem, and
wherein the home improvement-brokering system includes at least a purchasing subsystem and a servicing subsystem.

15. The CRM of claim 14, further comprising:
operating a broker-oriented application stack of the brokering platform at least in part from a primary memory of at least one server host of the brokering platform, the broker-oriented application stack including one or more web servers, one or more application servers, and one or more database servers,
wherein the one or more application servers include at least a web application configured for the real estate-brokering system and at least a web application configured for the home improvement-brokering system, and
storing the customer information in one or more databases by one or more database servers of the broker-oriented application stack for sharing among the lending personnel, the brokering personnel, or the one or more third parties; and
sharing among the lending personnel, the brokering personnel, or the one or more third parties the customer information in the one or more databases.

16. The CRM of claim 11, further comprising:
providing one or more interfaces with the lending-and-brokering environment including one or more application programming interfaces (“APIs”), one or more web applications, or at least one API and at least one web application.

17. The CRM of claim 16, further comprising:
instantiating a customer-oriented web application of a customer-oriented application stack configured to run at least in part from a primary memory of at least one server host of the lending-and-brokering environment;
accepting by the customer-oriented web application the customer information, inquiries regarding real estate, or a combination thereof;
sending by a web server of the customer-oriented application stack the customer information or inquiries to the one or more third parties; and
displaying by the web application relevant information to the customer information or inquiries received from the one or more third parties, one or more options to proceed with a real estate transaction, or a combination thereof.

18. The CRM of claim 17, further comprising:
storing the customer information or inquiries sent to the one or more third parties, the relevant information to the customer information or inquiries received from the one or more third parties, or a combination thereof as stored information in one or more databases by a database server of the customer-oriented application stack; and
sharing the stored information among the lending platform, the brokering platform, and the one or more third parties.

19. The CRM of claim 17,
wherein the relevant information to the customer inquiries received from the one or more third parties is one or more customer-specific artificial intelligence-generated predictive insights into existing and upcoming real estate for sale.

20. The CRM of claim 17,
wherein the customer information is at least details for real estate the customer would like to sell, the inquiries regarding real estate is at least details for real estate the customer would like to buy, and the one or more options to proceed with a real estate transaction is one or more financing options including at least a bridge loan based upon an instant appraisal for buying real estate corresponding to the details for real estate the customer would like to buy.
